(19) United States
(12) Patent Application Publication
(10) Pub. No.: US 2002/0150041 A1
(43) Pub. Date: Oct. 17, 2002

(54) Method and system for providing an improved quality of service for data transportation over the internet

(75) Inventors: Mendel Menachem Reinshmidt, Ra' anana (IL); Ithak Zur, Ra'anana (IL)

Correspondence Address: BROWDY AND NEIMARK, P.L.L.C., 624 NINTH STREET, NW, SUITE 300, WASHINGTON, DC, 20001-5303, US

(73) Assignee: ONETIER COMMUNICATIONS, INC., Wilmington, DE

(21) Appl. No.: 10/091,590

(22) Filed: Mar. 7, 2002

(30) Foreign Application Priority Data
Mar. 7, 2001 (IL) 141855

(51) Int. Cl. H04J 1/16; H04L 1/00

(52) U.S. Cl. 370/216; 370/389; 370/229

(57) ABSTRACT

Method and system for improving the quality of transportation of selected data packets over a data network. Selected nodes are determined as access points to the data network, such that each node may be a source node from which the selected data packets can be transmitted, or a destination node to which the selected data packets can be intended. One or more intermediate nodes are selected, for generating a plurality of alternative paths between the source node and the destination node. Each of the alternative paths consists of segments and includes one or more intermediate nodes for routing the selected data packets. The packet transportation parameters are periodically tested in the segments of each preselected path, each time by sending a plurality of test packets from the source node to the destination node, along the preselected paths defined by different intermediate nodes, the addresses of which are known to the source node. One or more optimal paths, being selected from the alternative paths are defined, for delivering the selected data packets from the source node to the destination node according to the tested transportation parameters. Optimal paths may also be defined according to predefined parameters characterizing the segments by selecting a combination of segments, connected to nodes, and having the optimal tested transportation parameters and/or predefined parameters, that connects the source node to the destination node. A modified header containing a single address or sequence of consecutive addresses that correspond to consecutive nodes along an optimal path, is generated for each selected data packet, and attached to the selected data packet. Each selected test/data packet is forwarded from the source node to the destination node along the optimal path(s), while at each intermediate node, along the optimal path, starting from the source, the modified header is processed and the address that corresponds to the next consecutive intermediate node is extracted. The selected data packet is forwarded from the intermediate node to its consecutive intermediate node using the extracted address. This process is repeated for all intermediate nodes until the destination node, at which the modified header is removing from the selected data packet and, whenever desired, its original header is used.

### FIELD OF THE INVENTION

The present invention relates to the field of data communication. More particularly, the invention relates to a method and apparatus for improving the Quality of Service (QoS) for the transportation of selected data packets over any IP-based network infrastructure, such as the Internet, or other multi autonomous systems networks.

### BACKGROUND OF THE INVENTION

The Internet system allows users access to different sources of data and also to send and receive various types of data to/from other users. Theoretically, the best possible network is a network, wherein there is only one global manager, and data routes are dynamically changing to accommodate to congestion status. Such a theoretical network would dynamically divert data packets as soon as a congestion state is about to occur. Because of the way the Internet today is extended, developed and managed, rather than having the desired network behavior, it has the following drawbacks:

1. Routers congestion—this problem is reflected in data packets being delayed or lost, and it becomes acute in times of “rush hours”, when numerous Internet users start to surf at the same time. This problem arises, because the Internet is a quasi-static network, namely the Internet network has, in general, a limited dynamic behavior. Congested routers are not bypassed, as data routes are changed only when a total collapse occurs in the network. Routers are capable of working according to several modes of operation. By choosing, theoretically, the most appropriate mode, it has the potential to dynamically re-route information within an Autonomous Systems (AS). Additionally, links within an AS may change to allow using the best possible route for each data packet. Nevertheless, routers are not fully exploited, since they are configured to work with limited dynamic behavior, because full dynamic behavior causes to instability in the network in terms of routing decisions.

2. The Internet comprises many different ASs, each one has a different routing policy and protocol. Each individual AS is still managed rather efficiently by its owner Internet Service Provider (ISP), in comparison to the Internet network as a whole, because the ISP controls, to some degree, the routes in which data is forwarded in his AS(s). The said relative efficiency of each AS is accomplished by using an Interior Gateway Protocol (IGP). Most of the ASs are implemented by using different kinds of protocols, and by using routers, which have been configured to operate in different modes. In most cases, data packets are required to be forwarded through several ASs that are owned by different ISPs. Therefore, the borderline between each two adjacent ASs is the weakest link in the Internet network, in terms of routing. No matter how efficient the data transportation is in each AS, the problem lays in the borderline between each two ASs, namely neighboring ASs do not efficiently cooperate with each other. Each time data packets have to exit one AS and enter another AS they are handled inefficiently. In order to alleviate the problem of forwarding data from one AS to another AS, an Exterior Gateway Protocol (EGP) is used. More recent version of this protocol is the Border Gateway Protocol (BGP-4, BGP version 4). Although this protocol was specially designed to ‘smooth’ transportation of data from one AS to another AS by using their dynamic capabilities, it was found that the dynamic behavior of the said protocols contributes to vibrations and instability in the routing mechanism. Therefore, these protocols are reduced to be quasi-static, with all the accompanying failings.

3. Each ISP has a different Data Exchange Policy (DEP). DEP refers to the commercial aspect of cooperation between two, or more, ISPs. According to such a DEP, an ISP may, or may not, use other ISP's routers to forward its own data packets more efficiently. In many cases, an ISP will not be able to use the best routers, even if they are available/free, simply because he has not signed up an agreement with the ISP who owns the specific free routers. As a result of this, such an ISP will have to send data packets by using longer and/or slower routes. In other words, ISPs agreements sometimes impose non-optimal routes, simply because of economical considerations.

4. Internet Network Management—as can be appreciated from the above paragraphs, the Internet is not a manageable network, since different and independent ISPs own and manage different parts of the network. Therefore, the Internet system can not offer an end-to-end policy or end-to-end control or optimization.

One of the most important parameters related to the transportation of data packets over a data network, is the QoS. The Internet has poor QoS since it has ‘unreliable’, or unexpected, nature. Consequently, Internet users are limited to applications that do not require high level of QoS. Additionally, since the form and rate of data flow over the Internet are not controllable or predictable, ISPs can not provide their users with a sufficient QoS for specific applications (such as voice and multimedia applications), and therefore the services that can be provided are limited.

Special attention is drawn today to the need to use Internet infrastructure to transportation audio/voice/video signals, and to enable live conversations, like in a PSTN (Public Switching Telephone Network), and multimedia applications. Data packets, except for voice and video packets, are not sensitive to delay in a sense that even when such a data is delayed, the original data integrity is maintained. On the other hand, Voice and video applications are very sensitive to delay in general, and to delay changes (i.e. jitter) in particular, since synchronization between data transmission and data reception is required. If the level of jitter is high, the original information is highly distorted and can not be successfully reconstructed.

As a consequence, Internet users may randomly suffer from poor quality of communication, resulting mainly in substantial dynamically changing delay of packets, low data rate and even packet losses. Access time is prolonged, and communication channels become slower. Under severe conditions, communication is even aborted, and a second attempt must be made to restore communication.

The solution of the above-mentioned problems is partly obtained by protocols such as Resource reSerVation Protocol (RSVP) and Multi-Protocol Label Switching (MPLS). Such solutions provide the subscriber a good, steady and satisfying QoS. However, the problem with this kind of solution is, that it offers no end-to-end management or control, and it is expensive, and therefore, it is not broadly used.

All of the methods described above have not yet provided satisfactory solutions to the problem of incapability to provide an improved QoS, when it comes to IP applications with broad commercial usage, particularly voice and multimedia applications. Moreover, the problem of poor and unreliable QoS becomes crucial, as it becomes a severe bottleneck when trying to implement the enormous potential of Internet (i.e. telephony, video, multimedia, data, VPN, e-commerce, internet etc.).

It is an object of the present invention to provide a method for providing an improved QoS for the transportation of selected data packets over the Internet network.

It is another object of the present invention to provide a method and system for improving data transportation from one autonomous system to other autonomous systems, in multiple-autonomous systems, which have no inherent end-to-end routing policy.

It is still another object of the present invention to provide a method and system for providing an improved QoS for the transportation of selected data packets over a data network that reduces jitter (changes in delay), caused by the network's infrastructure, or by other factors, in order to allow operating jitter-sensitive applications, such as IP Telephony, video and multimedia communications, using the existing Internet infrastructure

It is still another object of the present invention to provide a method and system for providing an improved QoS for the transportation of selected data packets over a data network with reduced delay.

It is still another object of the present invention to provide a method and system for providing an improved QoS for the transportation of selected data packets over a data network with reduced packet loss.

It is still another object of the present invention to provide a method and system for providing an improved QoS for the transportation of selected data packets over a data network with increased data rate (throughput).

It is yet another object of the present invention to provide a method and system that allow reducing the cost of telephonic services.

It is yet another object of the present invention to provide an improved transportation rate of data packets over an existing infrastructure of IP networks.

It is still another object of the present invention to provide an option to create and monitor at least one path for connecting any user to any other user that are connected to any type of IP-based network, such as the public Internet.

Other objects and advantages of the invention will become apparent as the description proceeds.

### SUMMARY OF THE INVENTION

The invention is directed to a method for improving the quality of transportation of selected data packets over an IP-based data network, such as the Internet.

The present invention is characterized by utilizing servers that are installed in the Customer Premises Environment (CPEs), each one of the servers contains a unique software package (hereinafter referred to as “Client Premises Qnode” —CPQ), and may be utilized as a source node and/or as a destination node, depending on whether it transmits/receives data/test packets. Preferably, for each link (i.e., between a source CPQ and destination CPQ), several alternative paths are preselected, one of which could be a default path, which allows transferring data between two CPE points without utilizing the CPQ software. The CPQ software allows the corresponding source node/CPQ to periodically monitor and analyze the (data) transportation parameters of each one of the preselected alternative paths, by forwarding test (i.e., Qping) packets between a source CPQ and a destination CPQ, via each one of the alternative paths. Accordingly, whenever a data packet is intended to be forwarded from one user (i.e., via a originating/source node/CPQ) to another user (i.e., via a destination node/CPQ), the originating/source CPQ determines (i.e., selects), based on the results of the paths' monitoring/analysis of the test packets, and after taking into consideration other parameters, the current optimal path(s) to the destination CPQ, and, accordingly, modifies the header of the data packet, thereby causing the data packet to be forwarded to the destination CPQ via the selected optimal path(s).

According to a first aspect of the invention, several Routers (hereinafter referred to as “Router Qnodes”—RQnodes), being inherent part of the backbone of the Internet, the addresses of which are ‘known’ to the CPQs, are utilized as intermediate nodes. A link between two CPQs may comprise several alternative preselected paths, and each one of the latter paths may include only one such intermediate node (i.e., RQnode). Accordingly, each packet's header is modified only once (“One Header Modification”—OHM), according to a first Header Modification Rule (HMR) rule.

In order to implement the OHM process, the present invention utilizes the “Internet Control Message Protocol” (ICMP). According to this protocol, packets, commonly known as ‘ping’ packets are utilized for monitoring networks nodes. A ‘ping’ packet is transmitted from one node (i.e., the source node) to another node (i.e., the destination node), and under normal (i.e., flawless) communication conditions, the packet reaches the destination node and returns to the source node, as an indication for the normal communications. In order to achieve the latter goal, the address of the source node, in the header, is defined as the (next) destination address (i.e., in the header of the ping packet), to which the ping packet is to be returned from the destination node. The source node's address is utilized, therefore, as the ‘return’ address, to which the packet returns. The present invention utilizes a modified version of the ‘ping’ packet concept, i.e., instead of sending a packet with the originating/source node's address as the return address, the packet's header is modified so that originating node's address in the ‘return address’ field is replaced with the address of a node, to which the packet is intended. Consequently, a packet may be forwarded from any node to any other (selected) node by utilizing a selected intermediate node (i.e., RQnode).

As the Internet inherently includes a large number of (backbone) Routers, there exists a large number of alternative paths, from each source CPQ to each destination CPQ, from which the source CPQ may select one, or more, optimal path(s) to the destination CPQs.

According to a second aspect of the invention, several dedicated servers (hereinafter referred to as “BackBone Qnodes”—BBQs) are connected to predetermined access points, through which the BBQs communicate with the IP-based network (e.g., the Internet). Several alternative paths are preselected between each two CPQs (i.e. one CPQ of which being a source node and the second CPQ being a destination node), and each path may include one or more BBQs. Normally, a CPQ software package resides in users/enterprises premises. However, a CPQ software package may reside also on the IP-based network (e.g. ISP premises). In addition, a CPQ residing in such an IP-based network (e.g. ISP premises) may also be utilized as a BBQ intermediate node in a path(s) linking other two CPQs, in which case the corresponding CPQ is referred to as a BBQ intermediate node. Several modifications would be required in packets' header if several BBQ intermediates nodes are utilized in specific path(s). The latter modifications are made by employing a second HMR rule.

The second HMR rule comprises adding, to the header of the selected packets, the addresses of the BBQs, in an order which corresponds to the order of the consecutive BBQs nodes along the optimal path, starting from the destination node to the BBQ being directly connected to the source node, so that whenever the selected packets are forwarded to one of the BBQs, the address of the current BBQ is removed from the header of the selected packets, thereby revealing the address of the next BBQ, for allowing the current BBQ to forward the packets, until the packets reach the destination node.

Each one of the CPQs ‘knows’ the address of each one of the BBQs, and, therefore, the CPQs, by sending test packets, are capable of evaluating (i.e., by monitoring/analyzing) the (data) transportation quality of each one of the alternative (predetermined) paths (i.e., between each two CPEs) and selecting the optimal paths at each given time, essentially in the same manner as described above.

According to a third aspect of the invention, one, or more, alternative/optimal path(s) may include essentially any combination of intermediate nodes, i.e., a path(s) may include at least one Internet Router (RQnode) and at least one BackBone Qnode (BBQ) as intermediate nodes. Test and data packets may be forwarded from a source CPQ via several BBQs and RQnodes (i.e., belonging to the same path), until the packets reach the destination CPQ. The packets header is modified according to the first/second HMR rules, which are employed by the corresponding source/BBQ node according to the intermediate nodes combination.

RQnodes may be placed, according to the first aspect of the invention and per path, between (i) source and destination CPQ nodes, or, according to the third aspect of the invention, (ii) between a source node and BBQ node, or (iii) between a destination node and a BBQ node, or (iv) between two BBQnodes. A plurality of paths are preselected between each source CPQ to each destination CPQ, each preselected path may include several BBQs and RQnodes, for allowing generating a plurality of alternative paths, that consist of segments, used for routing selected test and data packets.

In order to allow employing the invention according to the third aspect, the source CPQ adds, to the modified header, the type of each intermediate node (i.e., BBQ or RQnode) that is included in (the) specific path. Whenever a packet reaches a BBQ, the BBQ extracts, from the modified header of the packet, the address of the next node (i.e., whether it is an intermediate node or a final destination node) and the type of this node. If the next node is a BBQ node, the current BBQ node unwraps, from the modified header, its own address, thereby revealing the next (i.e., consecutive) address (i.e., the address of the next BBQ node. However, if the next (i.e., consecutive) node is an RQnode, the current BBQ node employs a process, which essentially resembles the latter process (i.e., regarding the next BBQ node), except that in the RQnode case, the current BBQ adds also an ICMP header.

A link between a source node and a destination node may comprise path(s) that include only one RQnode, and/or path(s) that include only BBQ(s), and/or combined path(s), i.e., path(s) that include, per path, RQnode(s) and BBQ(s). The CPQs are configured to handle all types of intermediate nodes. Accordingly, the selected optimal paths, between a source CPQ (node) and a destination CPQ (node), may be a combination of the three types of paths, i.e., several data packets, of a given application, may be transmitted from the source CPQ to the destination CPQ via optimal paths that include only intermediate Routers (i.e., RQnodes), other data packets of the same application (or other applications) from the same source to the same destination could be transmitted via paths that include only BBQs, and other data packets could be transmitted via paths that include a combination of BBQs and RQnodes. Each source CPQ is capable of determining which selected packets should be forwarded to the destination CPQ via which alternative path(s). Accordingly, the source CPQ selects the Header Modification Rule (HMR) rule, according to which the header of the corresponding packet(s) is modified.

The alternative paths may be created by:

1. According to the first aspect described above—using the inherent Internet Backbone routers is implemented by encapsulating the test (i.e., monitor) and data packets by the Internet Control Message Protocol (ICMP) Request header (i.e., by the corresponding CPQ). The (original/return) source address is replaced in the header by the real destination address, which is the address of the (destination) CPQ on the other end of the link. When the packet reaches the (intermediate) router/node (i.e., RQnodes), the router replaces the source and the destination addresses and sends ICMP Reply, so that the packet is forwarded to the real destination CPQ;

2. According to the second aspect described above—Defining selected intermediate points in the Internet backbone, or any other IP-based network, as nodes (i.e., BackBone Qnodes—BBQs), which are utilized as intermediate points in the data network. A plurality of paths are predetermined between each source CPQ to each destination CPQ, each of which may include several BBQs, for allowing generating a plurality of alternative paths that consist of segments used for routing the selected test and data packets; and

3. According to the third aspect described above—Defining selected access points in the Internet backbone as nodes (i.e., BackBone nodes—BBQs) and other nodes as RQnodes which are utilized as intermediate points in the data network. Test and data packets may be routed from each source CPQ through a number of BBQs and RQnodes until the packets reach the destination CPQ. However RQnodes can be located on any path, between (i) source and destination CPQ nodes (first aspect) or (ii) between a source node and BBQ node or (iii) between a destination node and a BBQ node or between two BBQ nodes. A plurality of paths are predetermined between each source CPQ to each destination CPQ, each of which may include several BBQs and RQnodes, for allowing generating a plurality of alternative paths that consist of segments used for routing the selected test and data packets.

The preselected alternative paths may include a path that is a default path, which allows transferring data between the source node and the destination node without utilizing the CPQ software package, i.e., by utilizing conventional software package(s).

Packet transportation parameters, in the segments of each preselected alternative path, are periodically tested by sending a plurality of test packets from a source CPQ to a destination CPQ, along the different paths that are defined by different intermediate nodes and their corresponding interconnecting segments. The transportation parameters may include the delay time of data packets from source to destination, time and/or the order of arrival of test packets through different alternative paths from the source to the destination, the variance of the delay time, and loss of packets and data rate (throughput). A QoS grade may be assigned to each optional path according to the tested transportation parameters and an optimal path(s) can be dynamically varied, as per QoS grade and/or according to predefined parameters (such as threshold requirements that correspond to a required QoS) and/or to the type of data packets to be sent from the source to the destination and/or other considerations (such as cost, availability, agreements with ISPs, date, time etc.). The decision algorithm selects the optimal path for each packet (or group of packets), so as to obtain the optimal performance for each session of the corresponding application.

The definition of each optimal path, from the source to the destination, may be dynamically varied, according to the testing results of the test packets and/or according to other considerations. Whenever a new optimal path is defined, data packets are sent from the source to the destination via the new optimal path. An optimal path may be a direct path (e.g., “default path”) between the source and the destination, which does not include any (intermediate) node.

The transportation of the different application types (data, voice, video, multimedia, etc.) packets from the source to the destination may be split between two or more optimal paths.

Data may be concurrently delivered from a source to a destination over several paths, and, optionally, by using weighted distribution of data between paths. The weighted distribution can be determined according to the desired level of QoS or other consideration for communication (e.g., cost) between the source and the destination.

Accordingly, whenever a data packet is intended to be forwarded from one user (i.e., via a originating/source node/CPQ) to another user (i.e., via a destination node/CPQ), the originating/source CPQ determines (i.e., selects), based on the results of the decision algorithm, selects the optimal path to the destination CPQ, and, accordingly, modifies the header of the data packet, thereby causing the data packet to be forwarded to the destination CPQ via the selected optimal path(s).

The invention is also directed to a data network, having improved quality of transportation of selected data packets, which comprises:

a. a plurality of nodes in the Customer Premises Environment (CPEs), which include software package (i.e., Client Premises Qnodes—CPQ) and may be utilized as a source from which the selected data packets can be transmitted, or as a destination to which selected data packets can be intended;

b. a plurality of intermediate nodes between the source CPQ and the destination CPQ, consisting of segments, for allowing generating a plurality of alternative paths, consisting of segments, for routing the selected data packets. A CPQ may be utilized also as an intermediate node, in which case it is referred to as BBQ intermediate node;

c. at one or more nodes and/or intermediate nodes, circuitry for sending a plurality of test packets from the source CPQ to the destination CPQ, along the preselected different paths that are defined by different intermediate nodes and their corresponding interconnecting segments;

d. processing means, for defining one or more optimal paths for delivering the selected data packets from the source CPQ to the destination CPQ according to the transportation parameters and optionally, also according to predefined parameters characterizing the segments, and for selecting a combination of segments, connected to nodes, and having the optimal sampled transportation parameters and/or predefined parameters, that connect the source CPQ to the destination CPQ;

e. at each source CPQ, processing means for generating a modified header, for each selected data packet, that contains a sequence of consecutive addresses that correspond to consecutive nodes along an optimal path and attaching the modified header to the selected data packet;

f. at each node along the optimal path, starting from the source node:

f.1) processing means, for processing the modified header and for extracting the address that corresponds to the next consecutive node;

f.2) circuitry for forwarding the selected data packet from the node to its consecutive node along the optimal path using the extracted address; and

g. at the destination node, processing means for removing the modified header from the selected data packet and for obtaining the original header of the selected data packet.

Preferably, a source CPQ comprises processing means for defining and monitoring one or more optimal paths, for delivering the selected data packets from the source CPQ to the destination CPQ, according to the transportation parameters and optionally, also according to predefined parameters characterizing the segments and/or nodes, and for selecting a combination of segments, connected to nodes, and having the optimal tested transportation parameters and/or predefined parameters, that connects the source CPQ to the destination CPQ. Further processing means may be included, for dynamically varying the definition of each optimal path from the source CPQ to the destination CPQ, according to the testing results and for sending data packets from the source to the destination over the new optimal path(s).

Replacements of (optimal) paths are dynamically controlled according to pure QoS grades considerations, or by employing other mechanisms, such as a threshold mechanism.

If a QoS grade is assigned to each optional or optimal path, the data network may further include processing means for dynamically varying the grades of such paths according to the tested transportation parameters and/or to the type of data packets to be sent from the source to the destination and/or other consideration, such as thresholds that may be assigned to relevant path(s) by employing threshold mechanism. Further processing means may be employed for splitting the transportation of data packets from the source to the destination between two or more optimal paths, such that more transportation is directed to, and distributed between, optimal paths having higher grades than the remaining optimal paths, and less transportation is directed to, and distributed between, the remaining optimal paths.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) schematically illustrates exemplary Internet routing in the Internet network;

FIG. 2 schematically illustrates implementation of Internet routing by utilizing BackBone Qnode (BBQ) as intermediate nodes, according to a one aspect of the invention;

FIG. 3 schematically illustrates implementation of Internet routing by utilizing inherent (regular backbone) Internet Routers (RQnodes) as intermediate nodes, according to another aspect of the invention;

FIG. 4 schematically illustrates implementation of Internet routing by utilizing combinations of BackBone Qnodes (BBQs) and Internet Routers (RQnodes) as intermediate nodes, according to another aspect of the invention;

FIG. 5 schematically illustrates an originator packet routing, according to a preferred embodiment of the invention;

FIG. 6 schematically illustrates an intermediate packet routing in connection with the BBQ-based path routing method depicted in FIG. 2;

FIG. 7 schematically illustrates a terminating packet routing, according to a preferred embodiment of the invention;

FIG. 8 schematically illustrates one exemplary RQnode-based path, according to another aspect of the invention;

FIG. 9 is a block diagram illustrating the primary software modules contained within a CPQ/BBQ, according to a preferred embodiment of the invention;

FIG. 10 is a block diagram illustrating the Monitoring and Data processes, according to a preferred embodiment of the invention;

FIG. 11 shows an exemplary link between a Source node and a Destination node, which includes “One Intermediate node” paths and a direct path, according to one aspect of the invention;

FIG. 12 illustrates an exemplary flow sequence of Qping and Qresponse packets in a link connecting 2 end-points, according to a preferred embodiment of the invention;

FIG. 13 illustrates the structure of the Qping packet, according to a preferred embodiment of the invention;

FIG. 14 schematically illustrates a Qresponse packet structure, according to a preferred embodiment of the invention; and

FIG. 15 schematically illustrates a typical data packet structure, according to a preferred embodiment of the invention.

### DETAILED DESCRIPTION OF PREFERRED EMBODIMENTS

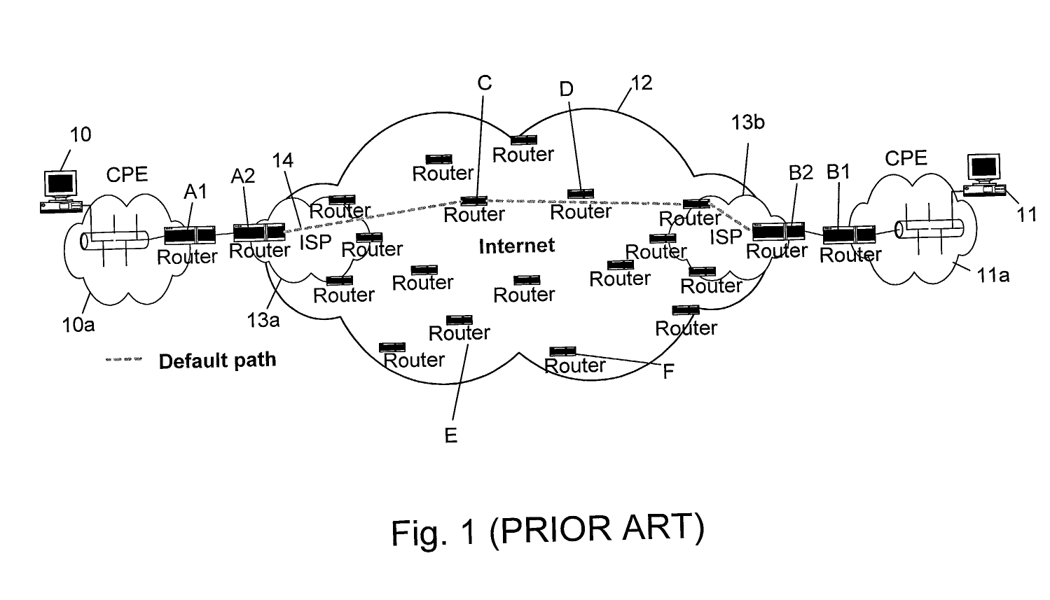

FIG. 1 (prior art) schematically illustrates exemplary Internet routing in the Internet network. End users 10 and 11 are connected to ‘local’ LAN network 10a and 11a, respectively, and may communicate with each other by connecting themselves to the Internet (12) via ISPs 13a and 13b, respectively. In such a network, data routing is static or, in the best case, quasi-static. This means that every data sent by end users 10 and 11 (and probably by other end users that are connected to same ISPs) is routed via the same path (14), resulting in congestion in, e.g., routers C and D, which are located along path (14). At the same time, other routers (e.g., E and F) may not be fully exploited. However, the routing scheme can not utilize unexploited routers due to its quasi-static nature. Therefore, other alternative paths, for connecting two end users 10 and 11 to each other, are not exploited even though they might offer better performance.

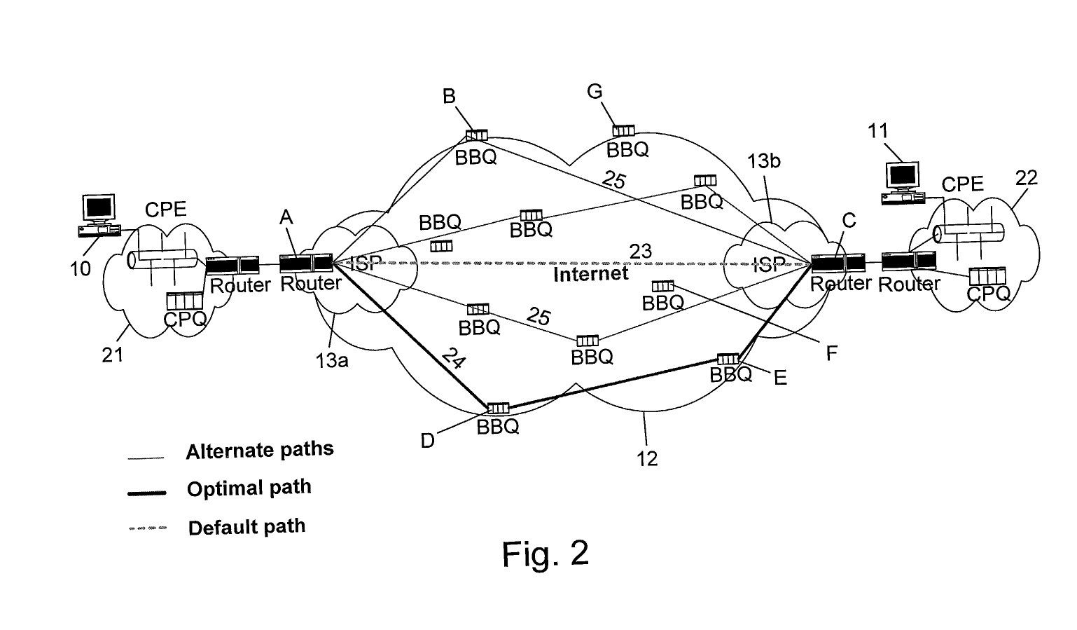

FIG. 2 schematically illustrates implementation of Internet routing by utilizing BackBone Qnode (BBQ) as intermediate nodes, according to one aspect of the invention. Several paths are preselceted, each of which includes at least a dedicated BBQ, which is connected to access point of the Internet, and is utilized as an intermediate node. According to a first example, an alternative path may include only one BBQ (i.e., BBQ B). According to a second example, a path may include two BBQs (e.g., a path that includes BBQ D and BBQ E). Preferably, the BBQs are deployed in pre-selected “strategic” points, which are points that are utilized for interfacing between ISPs (e.g., 13a and 13b) and the Internet, and/or for allowing efficient transportation of data packets. Particularly, a strategic point may also be determined according to other considerations, such as commercial and/or technical considerations.

Five exemplary paths are illustrated (FIG. 2) between end users 10 and 11. According to the example, path 23 is a default path, path 24 is an optimal path, and paths 25 are other preselected alternative paths. Additionally, or alternatively, other paths may be created. For example, a path may include BBQs F and G. Paths 23, 24 and 25 differ from the path that would normally be selected by conventional (quasi-static) routing scheme as shown in FIG. 1. The exemplary optimal path 24 is created by utilizing 2 BBQ's (i.e., D and E). However, other optimal paths, between users 10 and 11, could be selected from other preselected alternative paths.

Each Customer Premises Environment (i.e., CPEs 21 and 22) includes a Customer Premises Qnode (CPQ) software package, the task of which is to encapsulate the source user's packets (e.g., source user 10), as they are forwarded from the user, and to send them to the destination user 11 via the corresponding ISPs (i.e., 13a and 13b) and Internet 12, via, e.g., optimal path 24. Each address of the relevant BBQs is known to the corresponding CPQ, in order to allow the latter CPQ to preselect alternative paths, between the CPQ to the (other) potential destination CPQs, to monitor/test each preselected path and forward data packets via a selected optimal path(s).

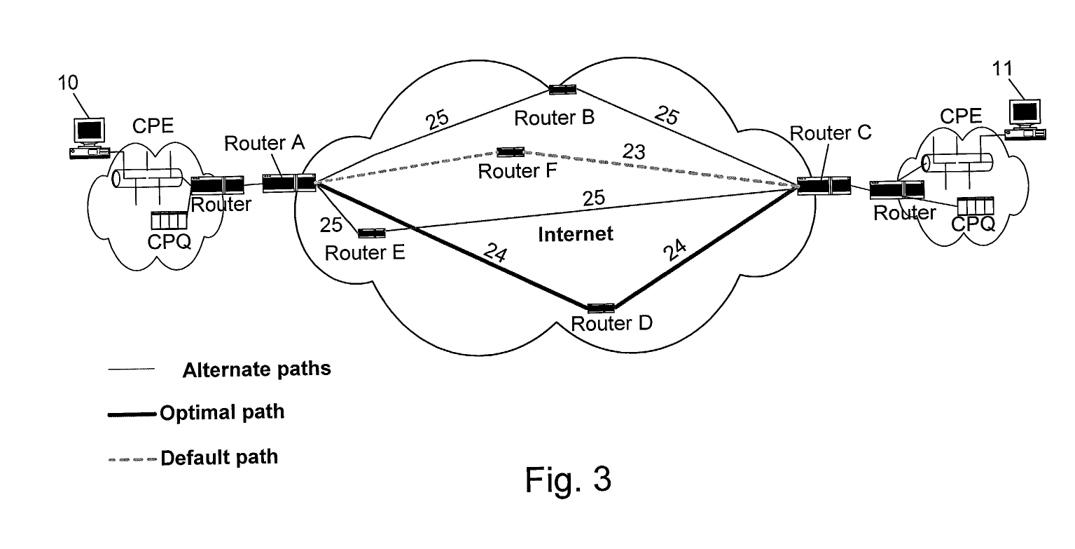

FIG. 3 schematically illustrates implementation of Internet routing by utilizing inherent (regular/backbone) Internet Routers (RQnodes) as intermediate nodes, according to another aspect of the invention. Exemplary RQnodes B, D, E and F are part of the Internet's inherent backbone, which are utilized for generating several alternative paths (i.e., RQnode-based paths) for transmitting data packets from user 10 (i.e., the source user) to user 11 (i.e., the destination user). For example, path 23 is a default path, path 24 is an optimal path and paths 25 are alternative paths. However, according to the invention, other/additional paths may be created by utilizing other/additional (not shown in FIG. 3) Internet's backbone Routers (RQnodes). Each one of the relevant RQnodes addresses is known to the corresponding CPQ, in order to allow each CPQ to preselect alternative paths, between the CPQ to the other CPQs, to monitor/test each preselected path and forward data packets via a selected optimal path(s). Data packets are transported along optimal RQnode-based paths by utilizing the Internet Communication Message Protocol (ICMP), according to which the ‘original’ source address (i.e., of the source CPQ) in the packet's header is replaced with the ‘true’/final destination address (i.e., of the destination CPQ), thereby causing the data packet to be forwarded to the required (i.e., final) destination, rather than being returned to the source CPQ.

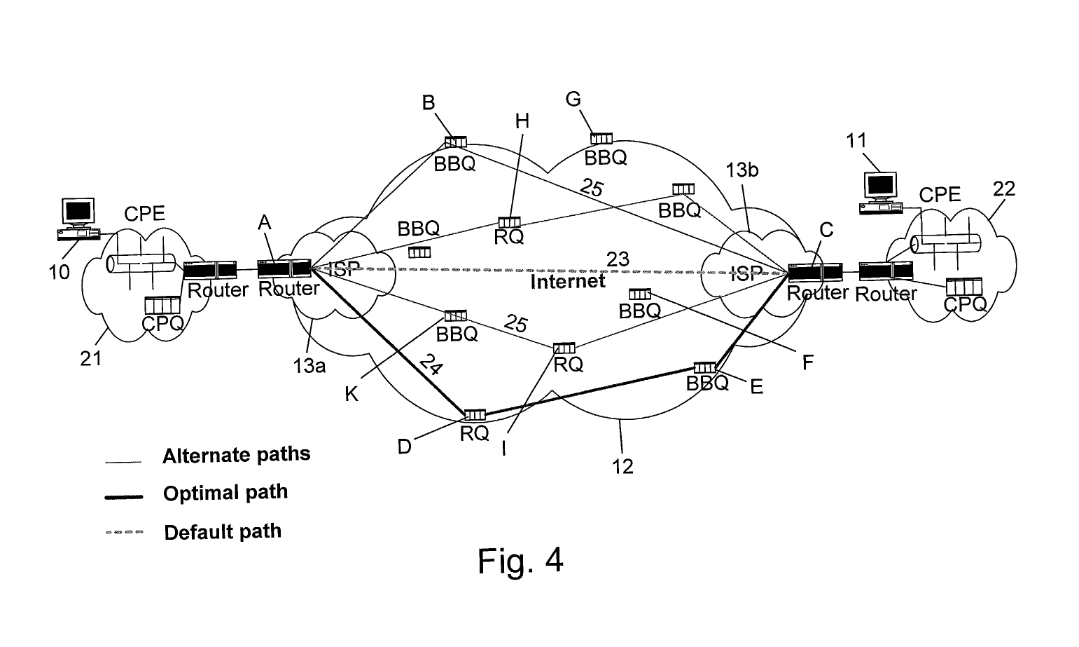

FIG. 4 schematically illustrates implementation of Internet routing by utilizing combination of inherent (regular) Internet Routers (RQnodes) and BackBone Qnode (BBQ) as intermediate nodes, according to another aspect of the invention. Exemplary RQnodes D, H and I, and BBQs B, E, F, G and K are part of the Virtual Private Network (VPN), which are utilized for generating several alternative paths for transmitting data packets from user 10 (i.e., the source user) to user 11 (i.e., the destination user). For example, path 23 is a default path; path 24 is an optimal path that comprises BBQ (E) and RQnode (D). Paths 25 are alternative paths, one of which comprises only BBQ and the other path comprises BBQ and RQnode. However, according to the invention, other/additional paths may be created by utilizing other/additional Internet's backbone Routers (RQnodes) or/and BBQs. Each one of the relevant RQnodes/BBQs addresses is known to the corresponding CPQ, in order to allow each CPQ to preselect alternative paths, between the CPQ to the other CPQs, to monitor/test each preselected path and forward data packets via a selected optimal path(s). When a packet reaches an intermediate node ((i.e., of ‘BBQ’ type), the type of next hop will determine whether an ICMP header should be added on top of the QFlow header, which will be handled normally.

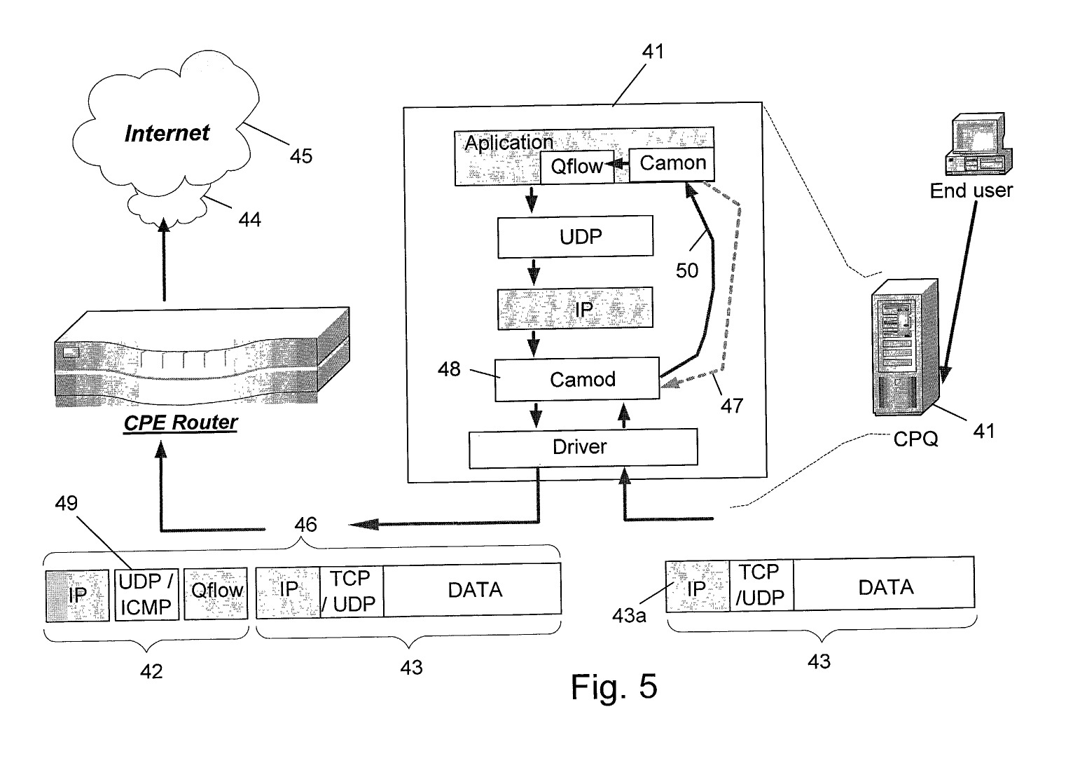

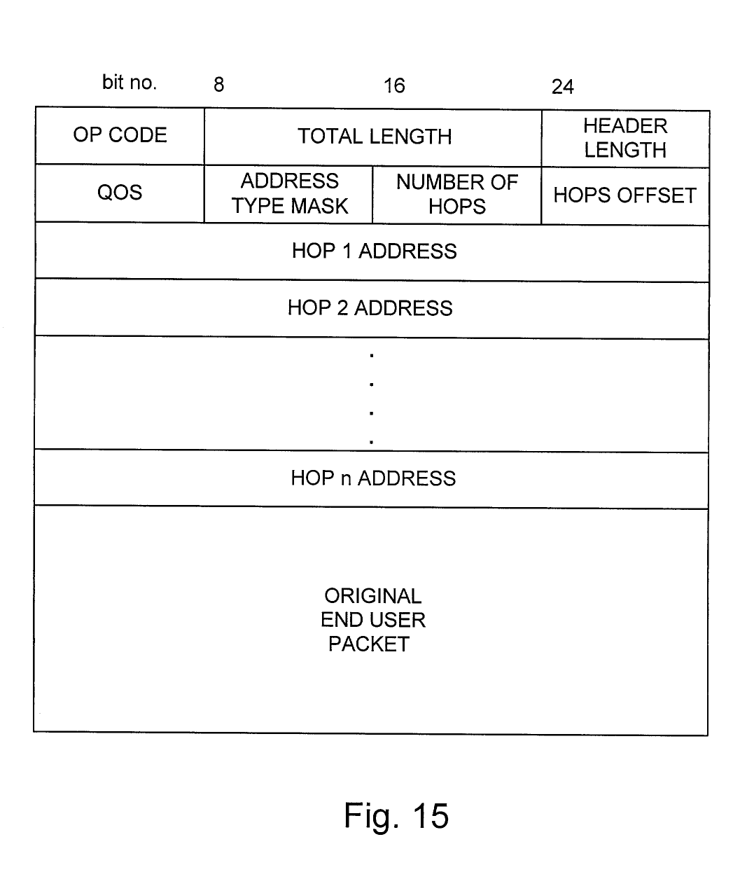

FIG. 5 schematically illustrates an originator packet routing, according to a preferred embodiment of the invention. Camod driver 48 (the kernel driver software) identifies whether CPQ 41 is an originator node or a terminator node, by comparing the IP address of the destination (43a) to the IP address of CPQ 41. As CPQ 41 is utilized, in this example, as an originator node, and since the integrity of the original packet (43) must be kept while traveling along the Virtual Private Network (VPN) path, the original packet (43) is forwarded directly (50) from Camod driver 48 to the Qflow application (i.e., bypassing the IP and TCP levels). The Camon interfaces between the Camod driver (48) and the Qflow application. Since the originator CPQ (41) maintains data associated with optimal paths to the final destination (i.e., the destination CPQ, not shown), its Qflow application level adds a new header (42) to the original packet (43), which contains data associated with the optimal paths and related intermediate BBQs if a BBQ-based path is utilized. If RQnode-based path is utilized, the Qflow application adds an ‘ICMP header’ that includes the address of the destination RQnode as intermediate node and the source CPE's address is replaced with the destination CPE's address. The latter process is implemented by forwarding (47) packet 43 to Camod 48. Referring now to FIG. 15, in case of utilization of BBQ-based path(s), the Qflow application implants an offset number into the header (i.e. ‘hopping number’), so that the next consecutive nodes, along the selected path, will be able to recognize whether the packet is to be forwarded to the next intermediate node, or it has arrived to the destination node. This type of decision is reached after comparing the offset number to the current hop number, which is updated every time the packet enters a node. If the offset number and the current hop number differ, the node puts the next consecutive (intermediate) node's IP address, to which the packet should be forwarded, as the next intermediate end station, in front of the packet, and updates the current hop number. The modified packet is then transmitted to ISP 44 (FIG. 5), and, from there, to Internet 45 (FIG. 5).

As a source CPE (e.g., CPE 41) may choose to transmit data packets either via RQnode-based paths or via BBQ-based paths, packet header 43 may undergo a ICMP or UDP modification process (49), respectively.

Internet routers handle the next known (i.e., to a source CPQ) intermediate node's address (i.e., BBQ and/or RQnode address), which was implanted into the packet's header, as if it was the final destination. Namely, routers do not have any information regarding the real final destination, or the additional intermediator(s) in the selected path. A User Datagram Protocol (UDP) is utilized to obtain high-speed end-to-end transmission.

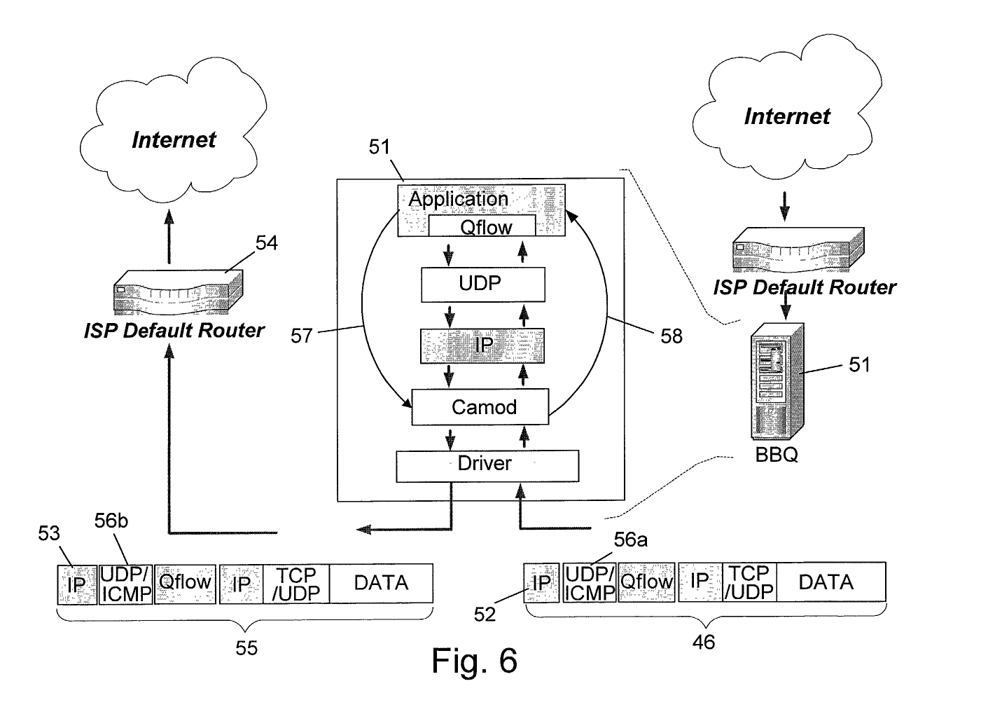

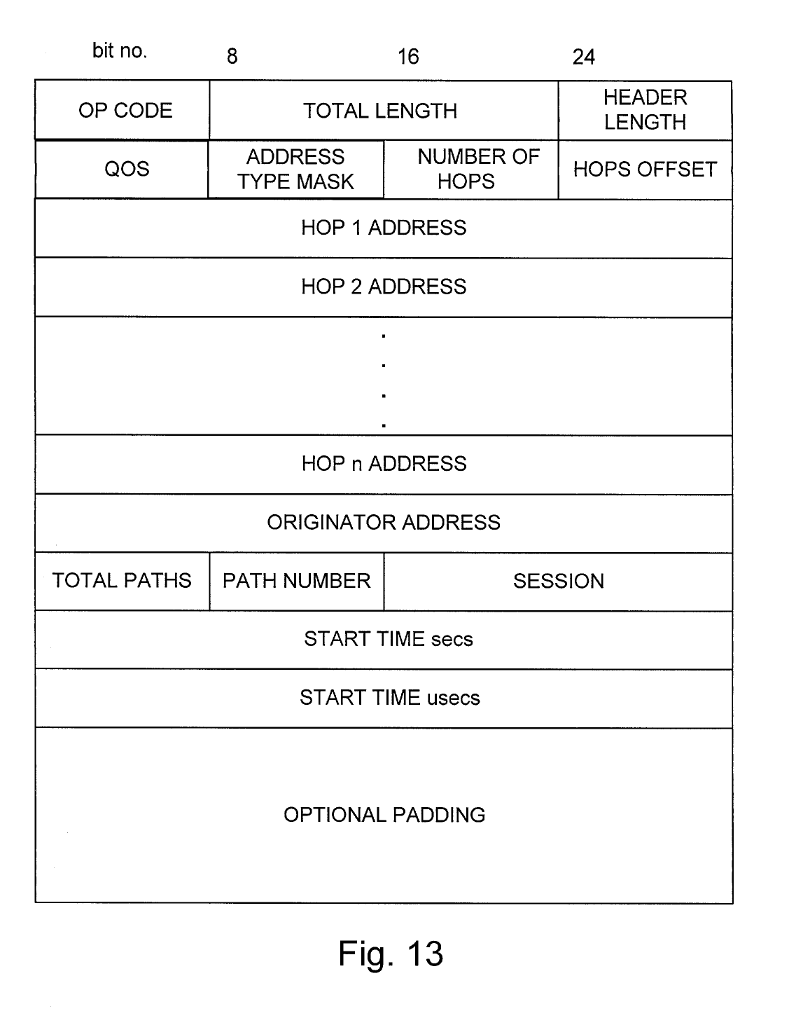

FIG. 6 schematically illustrates an intermediate packet routing in connection with the BBQ-based path routing method depicted in FIG. 2, or mix BBQ and RQ path routing method depicted in FIG. 4, according a preferred embodiment of the invention. If IP packet 46 is forwarded via a BBQ-based path (e.g., BBQ 51), it includes a header that is associated only with UDP process (56a and 56b). If the incoming packet arrives from a RQnode, its header is associated with ICMP protocol (56a). If the next hop type is RQnode, the ICMP header is added to the packet (56b). The Camod driver recognizes that packet 46 arrived from originator source (not shown) in a way described above. If packet 46 is identified, by the Camod driver, as a ‘UDP’ packet (i.e., by utilizing 56a), the Camod driver forwards packet 46 to the IP level, wherein the IP address (52) of the current node is extracted, and the next consecutive IP address (53) is ‘revealed’, to which the packet is forwarded (i.e., to the next consecutive node, being a BBQ node). However, if packet 46 is identified, by the Camod driver, as an ‘ICMP’ packet, the Camod driver forwards packet 46 directly to the Qflow application (58, 51) (i.e., bypassing the IP and TCP levels). Being an intermediate BBQ node, Qflow application 51 further forwards packet 46 to the Camod driver (54), from which the packet is forwarded to the next consecutive node, being an RQnode node. Referring also to FIG. 13, the Qflow application (FIG. 6) compares the hops offset number to the current hop number. The two latter numbers do not match, a fact which indicates that the current BBQ (51) is only an intermediate node. Therefore, the Qflow application updates the current hop number and inserts the next BBQ's IP address (53) into the packet's header, if it is intended for a BBQ node, or adds ICMP header, if it is intended for a RQnode node. The modified packet (55) is then forwarded to the local ISP default router (54), and from there to the next node (not shown), along the selected path in the VPN.

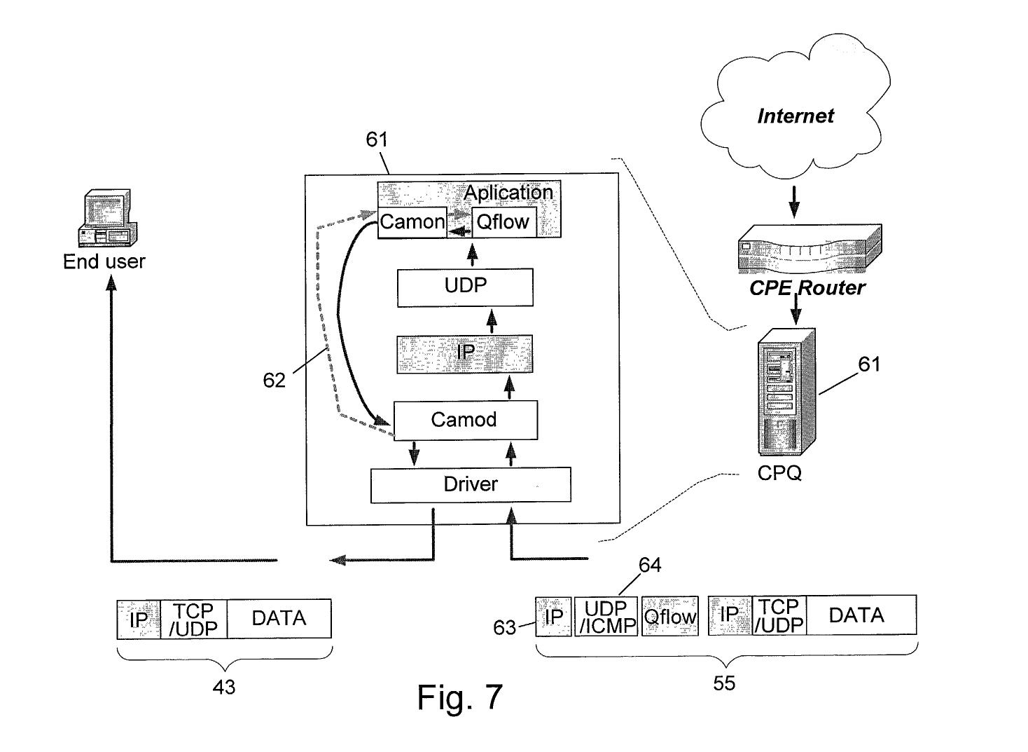

FIG. 7 schematically illustrates a terminating packet routing, according to a preferred embodiment of the invention. IP packet 55 enters destination CPQ 61. If a data packet has arrived via a BBQ-based path (i.e., in case of UDP packets see FIG. 5: 56a and 56b), the packet is forwarded to the IP level, wherein the current CPQ IP address (63) is extracted. If a data packet has arrived via a RQnode-based path (I.E., in case of ICMP packets), the Camod driver forwards (62) the packet to the Camon in the application layer. Referring also to FIG. 15, the Qflow level compares the offset number to the current hop number, and since they match, this indicates that this node is the final/terminating node. Accordingly, the packet is unwrapped, after which it resumes its original format 43 (see also FIG. 5), and is forwarded to the end user.

As a destination CPE (e.g., CPE 61) may receive data packets either via RQnode-based paths or via BBQ-based paths, packet header 55 may undergo an ICMP or UDP extraction process (64), respectively.

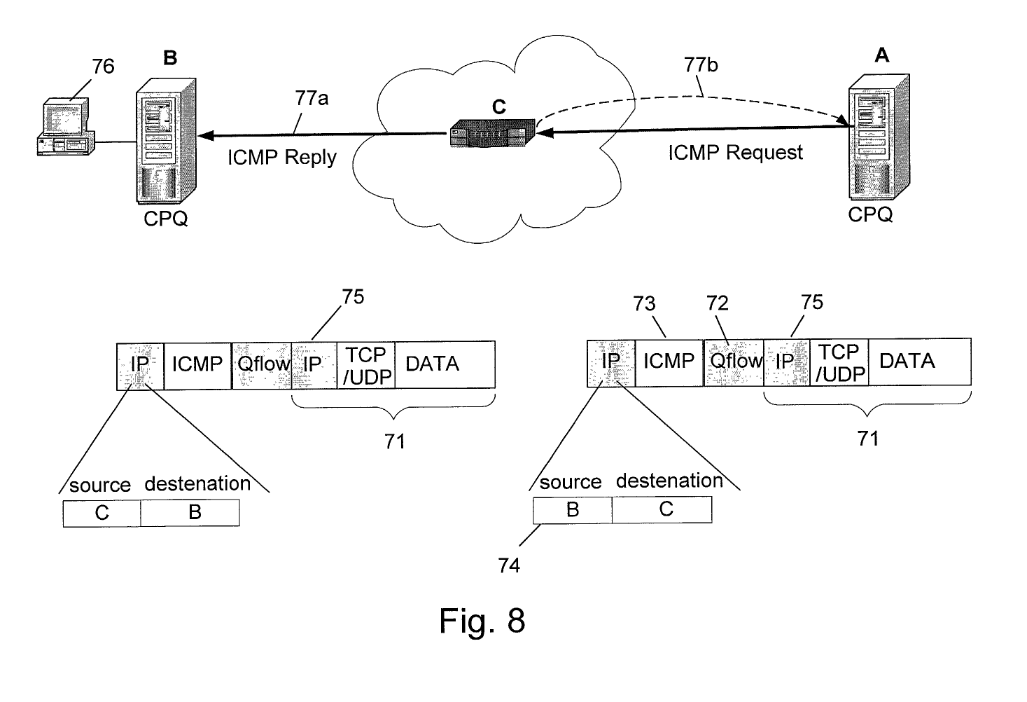

FIG. 8 schematically illustrates one exemplary RQnode-based path, according to a preferred embodiment of the invention. This figure shows ICMP request/reply data flow between source CPQ A and destination CPQ B, via intermediate Router, the address of which is known to source CPQ A. CPQ A encapsulates the original packet (71) with Qflow header and corresponding ICMP REQUEST header (72 and 73, respectively). The encapsulated packet is forwarded to Router C. Router C is inherently configured to respond to an incoming ICMP request message by sending a reply (ICMP) message to the request sender (i.e., CPQ A). However, since the original source address A is replaced, in CPQ A, with the address of the final destination CPQ B (74), Router C transmits the ICMP REPLY to CPQ B (77a) instead of returning the reply to CPQ A (77b). Upon receiving the ICMP REPLY, CPQ B de-capsulates the ICMP and the Qflow header, and sends the original packet to final end-user 76 in his site, according to its identified destination IP address (75).

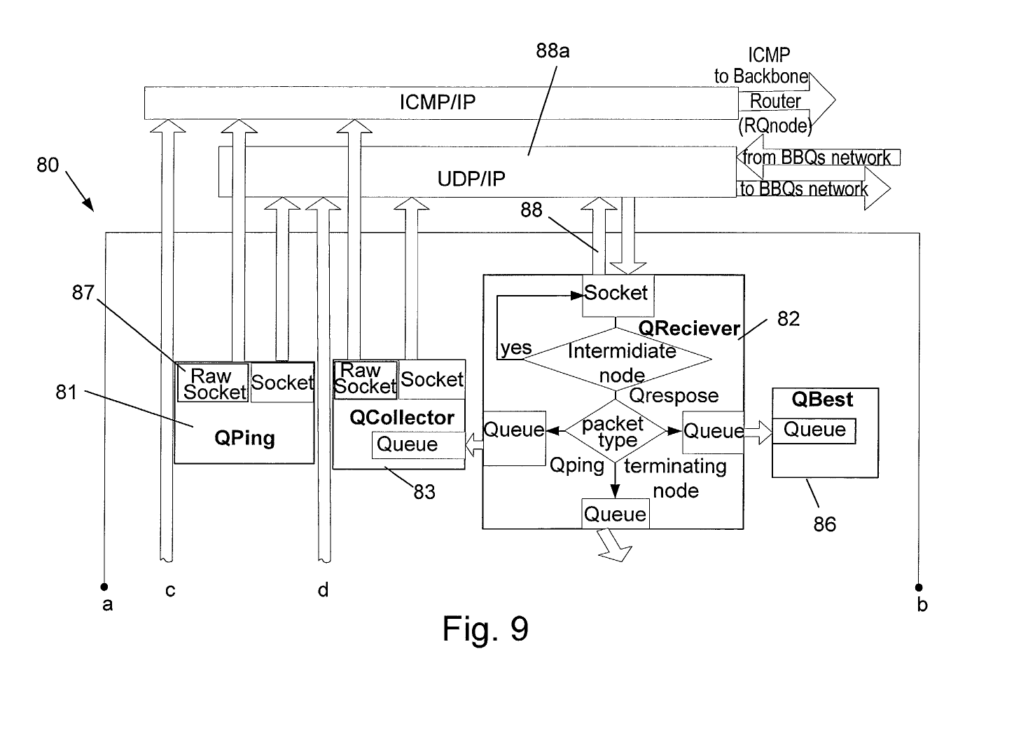

FIG. 9 is a block diagram illustrating the primary software modules contained within a CPQ/BBQ, according to a preferred embodiment of the invention. A key element in the invention is the Qflow layer/application, which encompasses several application software modules that run above the TCP/IP. The various software modules are associated with the following tasks:

1. Qping module 81, which creates and transmits unidirectional test (i.e., Qping) packets from one node (i.e., source CPE) to other nodes (i.e., destination CPEs). The purpose of these Qping packets is to allow measuring and calculating the corresponding path transportation's parameters, and, thereby, determining the fastest, or optimal, packet transportation paths between each two nodes.

2. Qreciever module 82, which determines whether a Qflow packet is intended to the current node (i.e., being final destination) or to another node. If the packet is not intended to the current node, it is forwarded onwards to the next consecutive hop in the VPN in the fastest possible way/route. Otherwise, it undergoes additional processing within the current node, after which the original data packet is forwarded to the destination end-user associated with the final node (i.e., CPE).

3. Qcollector module 83—if Qflow application 80 is the final destination, module 83 collects the received Qping (i.e., test) packets and sends Qresponse packet(s) to the originating node(s).

4. Qdatain module 84, which handles data that is forwarded to it by end user(s). The ICMP REPLY packet (in a termination CPQ) is also handled by this process, I which case this module de-capsulate the ICMP header and sends the packet to the other relevant processes queue, essentially in the same manner the Qreciever does.

5. Qdataout module 85, which handles data that is to be forwarded to end user(s).

6. Qbest module 86, which manages tables for processing the Qdata (out/in) and, optionally, other types of data.

Qping module 81 sends a testing (i.e., Qping) packet to the far end of the link (i.e., the final destination/end-user, not shown). Whenever a BBQ-based path is involved in packets transportation, the corresponding packet traverses the TCP/IP stack of the originating node. Alternatively, whenever a RQnode-based path is involved, the corresponding packet is encapsulated with an ICMP header and forwarded to the intermediate node (Router). Upon arrival at an intermediate BBQ node, such as BBQ 80, Qreciever 82 increases the header's offset by one, wraps the packet with the IP address of the terminating node, and forwards the packet onwards (88). At the terminating node, in the BBQ option, the packet traverses the TCP/IP stack, and is sent to Qcollector module, such as module 83. If the received packet is of ‘ICMP type’, Camod 89 forwards the packet to Qdatain module, such as module 84, which places the packet in the Qcollector queue (83). The terminating node has to return a response packet/message, and in order to do so, the terminating node becomes the source node, and vice versa.

In connection with the processing of the response packet, Qcollector 83 sends a packet back to the Qping originator. The packet traverses the TCP/IP stack of the originating node in BBQ option, or being encapsulated with an ICMP header according to the ICMP option. The packet is forwarded, by the Qflow process, to Qbest module 86.

An originator CPQ, such as CPQ 80, registers the time, at which the Qping packet is initiated/sent. The time of its arrival at the Qcollector (83) of the terminator node is registered in the packet, and extracted in the Qbest (86) process, in the (now) terminating node. Sessions that include sending Qping packets to terminating node(s) and receiving the corresponding response(s) in the originating node(s) are carried out through different intermediate node(s), and their travel times are recorded in each originating node. The latter procedure allows the originating nodes to assign a QoS/weight level to each potential route/path in the VPN, from which several routes, which meet predetermined efficiency criteria (i.e., being the optimal paths), are selected.

A data packet from one end-user arrives via the network (89a) to the originating CPQ. Camod driver 89 sends the packet directly to Qdatain module 84. Since the originating node receives the original packet, which contains the final end user IP address, the Qdatain module (84) chooses the optimal path information and creates the Qflow header and encapsulates the original packet with the Qflow header and sends it to the UDP/IP stack, according to the BBQ option, or complete the ICMP and IP header and sends the packet directly by raw socket in ICMP path. In the terminating CPQ, the packet is unwrapped from the last Qflow header, and is forwarded to the Qdataout, such as Qdataout 85, and from there to the recipient end user (89b), via the local ISP.

Qping Testing Guidelines and Process

The Qping transmitting/receiving process allows each source/originating CPQ to periodically monitore/measure all the possible paths, and to update its tables accordingly. Qpings are initiated periodically while the time-out between them are likely to vary as a function of the actual link/path, and/or as a function of time.

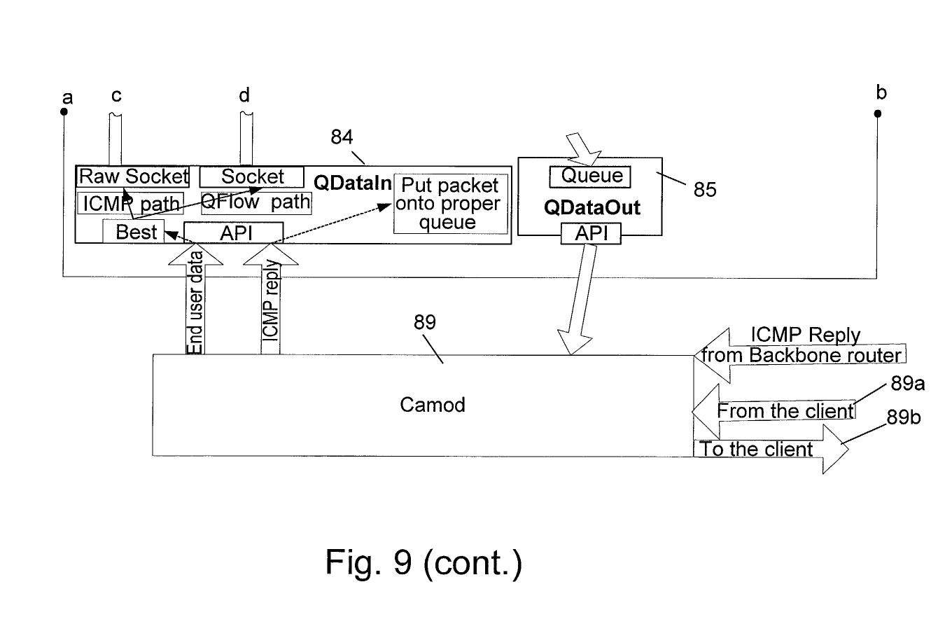

FIG. 10 is a block diagram illustrating the Monitoring and Data processes, according to a preferred embodiment of the invention. The Monitoring/Data processes describe typical flow of monitoring (i.e., Qping and Qresponse) packets and data packets. Qping packets, which are intended to different possible final destinations, are sent to the Internet (99a) at time instants (99c) that are determined according to parameters associated with individual alternative path. Whenever a Qping is received at a terminating CPQ (not shown), a Qresponse message is generated (i.e., in the terminating CPQ), which contains information about the data rate, latency, jitter and packet loss for each path. The Qresponse is transmitted from the terminating CPQ and received in the originating CPQ (99d), and the required information (e.g., data rate, latency, jitter and packet loss) associated with each path is recorded in database 96 (this includes all relevant information, both current and historical, for all defined parameters within a particular link(s)). Each newly received Qresponse is evaluated in Optimization process 95, and, whenever required, optimization Database 96 is updated according to the evaluation results.

A data packet is transmitted from end user 10 to the source CPQ 90, wherein it is first identified (91), after which its link and type information are determined (92) by utilizing table 93. The latter information is utilized for choosing the optimal path, which may be changed according to the type of packet. Information regarding the current optimal path(s) for current packet is requested (94a) from optimization database 96. When the latter information is obtained (94b), the packet is encapsulated (97) by the Qflow header and sent to the Internet. “Encapsulation” involves modification of the packet's header so that it includes the addresse(s) of the intermediate node(s) that are included in the optimal path(s). CPQ 90 is configured to be utilized also as destination/terminating node. Accordingly, whenever a data packet is transmitted to a terminating CPQ, such as CPQ 90, the data packet is de-capsulated (98a) and sent to end user (98b), such as end-user 10.

A corresponding weight is assigned to each parameter measured during the monitoring process/phase, which is associated with the related application. These weights are stored in a separate database. Scoring numbers are assigned to each path, based on the information contained in the Qresponse packets, and the weighing factors table. The score for each path is stored in a database, in which the best path(s) for each application is stored.

The information stored in Database 96 allows making precise calculations regarding the optimal path for each type of path, i.e., for a RQnode-based path, and for a BBQ-based path, and for each type of application, for example, voice, video, multimedia and other possible types of applications. Furthermore, as the information regarding the optimal path(s) is stored in a database, ready to be fetched, there is no need to waste time making optimization calculations upon receiving of new data packets. Accordingly, the CPQ responds to the currently received packet almost instantly, thereby making the CPQ essentially transparent to the data packets.

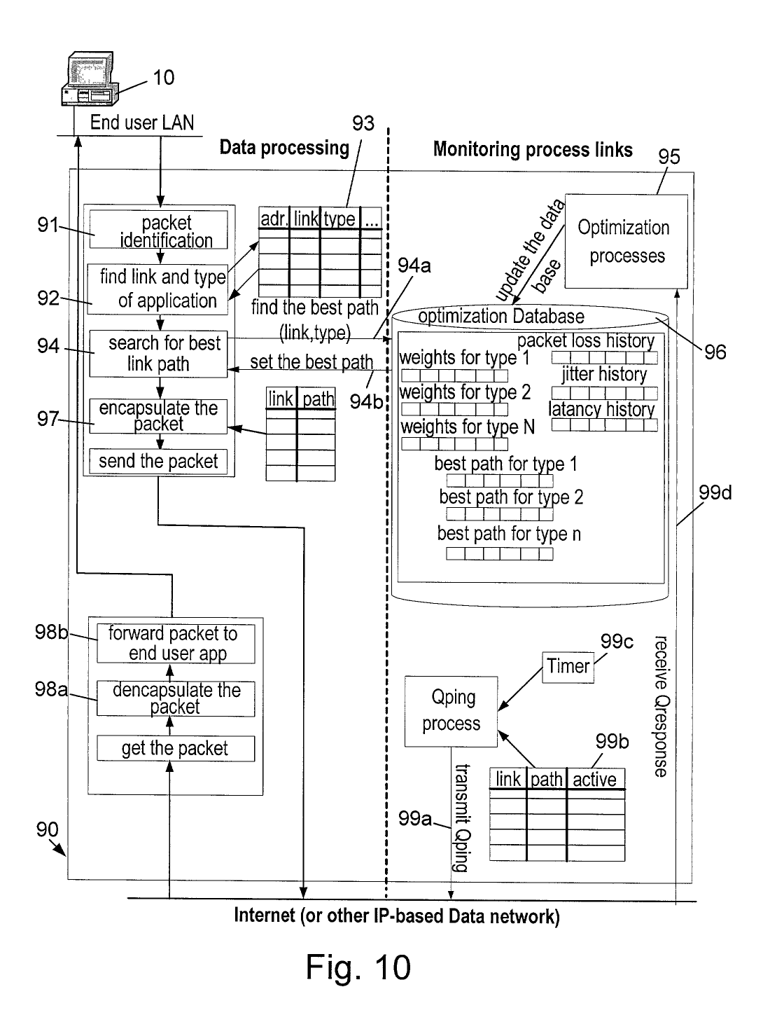

FIG. 11 shows an exemplary link between a Source and a Destination, which includes “One Intermediate node” paths and a direct path, according to one aspect of the invention. According to this example, the VPN comprises five possible/valid alternative routes/paths (i.e., “A-B-E”, “A-C-E”, “A-E”, “A-D-E” and “A-F-E”), which include a maximum of one hop (i.e., intermediate node). However, as is explained above, alternative paths may include several intermediate nodes. These five paths are an example for paths that are predefined by deploying corresponding CPQs. However, new/additional alternative paths could be defined and added later on, which may comprise combinations of already existing BBQ/Routers and/or new installed BBQ. In addition, new strategic Internet backbone's Routers could be included in the VPN, in order to implement the ICMP option in the way described before.

The ‘transportation quality’ of every valid alternative path is evaluated, as described above. The evaluation process is carried out by sending “Qpings” (test packets) between every originator/source node and every terminating/destination node. Accordingly, originating (CPQ) node A forwards Qping packets via the five paths to the terminating (CPQ) node E. Upon receiving these Qpings, the terminating node E measures the propagation time of the first received Qping and the time intervals between each subsequently received Qpings. This information is transmitted, as a response message, to source node A. Since node A registers the Qpings departure/transmission times and receives their arrival times at E, by the Qresponse packet, the propagation time of each path is calculated and registered in a ‘A-to-E’ routing table (see also Database 96 in FIG. 10). For example, if a path through BBQ/Router C is extremely congested, the corresponding Qping packet may not reach the terminating node E, in which case this packet is recorded as a lost packet. Consequently, such a path will not be utilized for data transmission. Node E (the destination) completes the Qping evaluation process whenever at least one of the following three conditions is met:

all Qpings are received at node E (the total number of Qping packets is inserted in each Qping packet before it is transmitted by node A);

after a time-out from receipt of first Qping;

a new Qping session is received at node E.

At the end of the Qping reception process, node E sends a response packet to the originator node A; i.e. a Qresponse packet, which carries the measurements results. Upon receipt of the Qresponse packet at the originator A node, originating node A initiates an evaluation process, for evaluating the various possible alternative paths to destination E, based on the information contained in the Qresponse packet(s), but also on additional factors, such as:

historical data (e.g., lost packets, delay jitter);

preset conditions inserted via the VPN Network Manager like, such as cost factors associated with various paths;

limitations in using several intermediate nodes; and

type of data (voice, video, file transportation etc.).

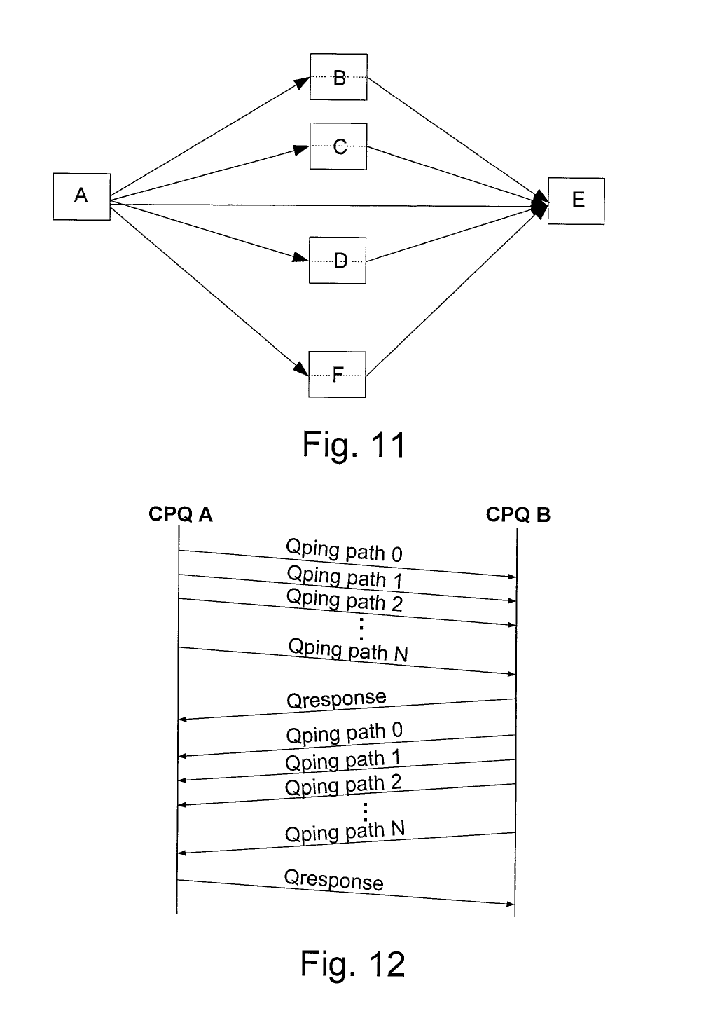

FIG. 12 illustrates an exemplary flow sequence of Qping and Qresponse packets in a link connecting 2 end-points, according to a preferred embodiment of the invention. The link between CPQ A and CPQ B includes N possible alternative paths. Accordingly, CPQ A transmits N Qping packets, each of which is transmitted via one alternative path associated with this link, and receives the corresponding Qresponses from CPQ B. CPQ B does the same but in reverse, i.e., it transmits Qping packets, via the (same) alternative paths, to CPQ A and receives, from CPQ A, the corresponding Qresponses.

At the end of the evaluation process, CPQ A assigns a quality factor to each alternative path. Different quality factors are assigned to different types of traffic, applications (e.g., voice, data, video, multimedia, etc.) and customers. The combination of said measured paths' quality with the application's parameters determines the paths' weight. In addition to the weight factor, other predefined parameters/factors are involved in choosing the optimized paths. The higher the weight of a path(s), the better the path(s) suits a specific application or user. Each path might have different weights at the same time, since a path may be considered as an adequate path for data packets, thus having a relatively high weight, while the same path may be considered as a poor path for voice packets, thus having a low weight.

Referring again to FIG. 11, there are several options, by which data packets may be forwarded from CPQ A (i.e. the originator node) to CPQ E (i.e. the terminating node). For example, one option is via one optimal path. Another option is to forward data packets via two or more optimal paths (i.e. ‘multi-path’ data transportation). CPQ A may decide to employ the multi-path option in order to implement load balancing. The multi-path option may be utilized in various ways, one of which is allocating several specific paths to one specific application at a time, provided that each path meets the weight requirement. Another way to utilize the multi-path option is, to allow several applications to share some, or all, of the paths; namely optimal paths are utilized intermittently by several applications. Accordingly, originating CPQ A may decide, for example, to start sending voice packets to node E through BBQ/router B and C, and data packets through BBQ/router D and F. However, at a later stage, CPQ A may decide, for example, to divert voice packets to BBQ/router C or F, and data packets to BBQ/router F or C. Routing changes, such as the changes described above, are made dynamically by the originator CPQ A, and are based essentially on weights that are assigned to each alternative path and are constantly updated.

FIG. 13 illustrates the structure of the Qping packet, according to a preferred embodiment of the invention. The fields in this type of packet are:

1. ‘OP CODE’—this field contains an operation code indicating a Qping packet.

2. ‘TOTAL LENGTH’—this field contains the length of the Qping packet, excluding the ‘OP CODE’ and length fields.

3. ‘HEADER LENGTH’—this field contains the length of the header in ‘double digital words’.

4. ‘QOS’—this field contains a flag that indicates the Quality of Service level assigned to this packet.

5. ‘ADDRESS TYPE MASK’—The required field in the QFlow header will be an 8-bit field, whose bits represent the type of node used for each hop.

6. ‘NUMBER OF HOPS’—the total number of nodes, through which the packet is to be forwarded, from the originating node to the terminating node. This field is relevant (i.e., its value being greater than zero) only whenever a packet is forwarded via a BBQ-based path. Alternatively, whenever a packet is forwarded via a RQnode-based path, (i.e., utilizing the ICMP option), this field is assigned a zero/nil value)

7. ‘HOPS OFFSET’—a counter that counts the current number of BBQ-type intermediate nodes, that the packet is currently traveling through. In other words, each time the packet reaches the next BBQ intermediate node, this counter is incremented by one. This field is relevant only for the BBQs option. In the ICMP option this field is assigned a zero/nil value.

8. ‘HOP 1 ADDRESS’—this is the address of the first BBQ intermediate node, to which the packet is forwarded. This field is relevant only for the BBQ option. In ICMP option it does not existing. The next ‘HOP i ADDRESSES’ (i.e., ‘HOP 2 ADDRESS’ to ‘HOP n−1 ADDRESS’) are additional consecutive addresses of corresponding consecutive intermediate BBQ nodes along the selected path.

9. ‘HOP n ADDRESS’—this is the address of the termination/node. This field is relevant only for the BBQ option. In ICMP option it does not existing.

10. ‘ORIGINATOR ADDRESS’—this is the IP address of the node that generated the Qping packet. This address is required in order to allow the terminating CPQ node to send the Qresponse packet to the originating/source CPQ node, namely to send a response back to the initiating CPQ.

11. ‘TOTAL PATH’—the total number of paths in the VPN, through which the originating CPQ sends Qping packets to the terminating CPQ. This number allows the terminating CPQ to determine when a Qping session is completed (i.e., no more Qping packets were sent from the originating CPQ), so that it would not have to wait for other Qping packets to arrive. After having received all the expected Qping packets (from a specific originating CPQ), the terminating CPQ starts to send response (i.e., Qresponse) back to the originating CPQ node.

12. ‘PATH NUMBER’—this is the path number of this Qping packet. This number is required in order for the originating CPQ to match the propagation (delay) time to the corresponding path, so that it can assign the right quality to the right path.

13. ‘SESSION NUMBER’—this is the session number of this Qping.

14. ‘Start Time [seconds]’—the time (in seconds) that this packet was sent from the originating node.

15. ‘START TIME [miliseconds]’—the time (in miliseconds) that this packet was sent from the originating node.

16. ‘OPTIONAL DATA PADDING’—optional number of bytes, to simulate packets of various sizes.

Qping packets with the same format are forwarded along each one of the predefined alternative paths from every originating CPQ to every terminating CPQ. The decision, to be taken by an originating node, regarding when and with whom to start a Qping session, is determined on the basis of efficiency. Preferably, active paths will be monitored frequently, while non-active paths will not be monitored at all, in order not to interfere (i.e. not to load) with the normal operation of the Internet network. However, other modes of Qping/monitoring sessions, which comply with the limits of the efficiency and network congestion criteria, could be implemented, without exceeding the scope of the present invention.

After all of the Qping packets, which were transmitted from an originating node to a terminating node, arrive at the terminating node, the terminating node starts sending back the corresponding response (i.e., Qresponse packet).

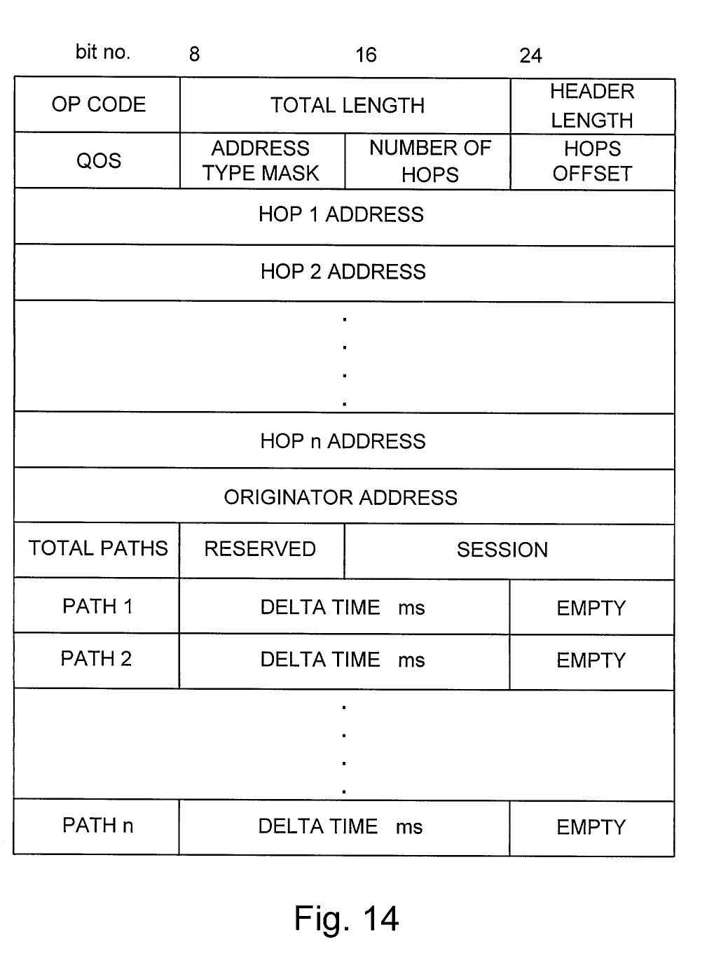

FIG. 14 illustrates the structure of the Qresponse packet, according to a preferred embodiment of the invention. The fields in this type of packet are essentially similar to the fields of the Qping packet, except the following fields:

1. ‘OP CODE’—this field contains an operation code indicating that this is a Qresponse packet.

2. ORIGINATOR ADDRESS'—this is the IP address of the current node, that is sending this Qresponse packet. This address allows the originating CPQ to identify the source of received Qresponse packet so that it can match a specific route to a specific terminating node.

3. ‘PACKET TIME STRUCTURE 1’—this raw, in the table, contains the path number and the propagation time of the fastest path. The better the path, the smaller this number.

4. ‘PACKET TIME STRUCTURE n’—contains the path number and the delta time between the fastest path and path number ‘n’, where ‘n’ is the number of paths.

After the originating node measures the time delay to the terminating node, over the predefined alternative paths, it selects the most appropriate paths (i.e., optimal paths) for each data packet.

FIG. 15 illustrates the structure of a typical data packet, according to a preferred embodiment of the invention. The fields in this type of packet are essentially similar to the fields of the Qping packet, except the following fields:

1. ‘ORIGINAL END USER PACKET’—this is the original end user data packet. All of the previous fields, from the ‘Op Code’ to the ‘Hop n Address’, are added to the original data packet by the originating CPQ node (i.e., by employing the Qflow application), in order to forward the data packet across and over the VPN. The Internet backbone Routers do not have any information regarding the real final destination (i.e. end user's IP), but only information regarding the next intermediate BBQ/Router, as is reflected in the modified header of the data packet (see FIG. 4 for wrapping the original Qdata packet, 43, with a new header 42).

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for improving the quality of transportation of selected data packets over a data network, comprising:
a) determining selected nodes as access points to said data network, each of which may be a source node from which said selected data packets can be transmitted, or a destination node to which said selected data packets can be intended;
b) selecting one or more intermediate nodes, for generating a plurality of alternative paths, between said source node and said destination node, each one of said alternative paths consists of segments and includes one or more intermediate node(s), for routing said selected data packets;
c) periodically testing the packet transportation parameters in the segments of each preselected path, each time by sending a plurality of test packets from said source node to said destination node, along said preselected paths defined by different intermediate nodes, the addresses of which are known to said source node,
d) defining one or more optimal paths, being selected from said alternative paths, for delivering said selected data packets from said source node to said destination node according to said tested transportation parameters and optionally, also according to predefined parameters characterizing said segments by selecting a combination of segments, connected to nodes, and having the optimal tested transportation parameters and/or predefined parameters, that connects said source node to said destination node;
e) for each selected data packet, generating a modified header containing a single address, or sequence of consecutive addresses that correspond to consecutive nodes along an optimal path, and attaching said modified header to said selected data packet;
f) forwarding each selected test/data packets from said source node to said destination node along said optimal path(s), while at each intermediate node, along said optimal path, starting from the source:
f.1) processing said modified header;
f.2) extracting the address that corresponds to the next consecutive intermediate node;
f.3) forwarding said selected data packet from said intermediate node to its consecutive intermediate node using the extracted address;
f.4) repeating steps f.1) to f.3) for all intermediate nodes until said destination node; and
g) at the destination node, removing said modified header from said selected data packet and, whenever desired, allowing using its original header.

2. A method according to claim 1, wherein the data network is the Internet, or any other type of IP-based network.

3. A method according to claim 1, wherein one or more nodes are used as intermediate nodes.

4. A method according to claim 1, wherein the test packet does/does not contain.

5. A method according to claim 1, wherein the transportation parameters are selected from the following group of parameters:
the delay time of data packets from source to destination;
the variance of said delay time; and
loss of packets.
Data rate (throughput)

6. A method according to claim 1, wherein data is concurrently delivered from a source node to a destination node over several different paths.

7. A method according to claim 6, further comprising using weighted distribution of data between paths.

8. A method according to claim 7, wherein the weighted distribution is determined according to the desired level of QoS between the source node and the destination node.

9. A method according to claim 4, wherein the definition of the optimal path is carried out by measuring and storing the time and/or the order of arrival of test packets through different paths from the source node to the destination node.

10. A method according to claim 1, further comprising:
a) dynamically varying the definition of each optimal path from the source node to the destination node, according to the testing results, or by employing a threshold mechanism; and
b) whenever a new optimal path is defined, continuing sending data packets from said source node to said destination node over said new optimal path.

11. A method according to claim 1, wherein the optimal path consists of direct connection between the source node and the destination node.

12. A method according to claim 1, wherein the predefined parameters are selected from the following group of parameters:
cost;
availability;
agreements with ISPs;
data type;
agreement with customers;
Date and/or time.

13. A method according to claim 1, wherein a QoS grade is assigned to each alternative path according to the tested transportation parameters and/or predefined parameters that correspond to a required QoS and/or to the type of data packets to be sent from the source node to the destination node.

14. A method according to claim 13, further comprising dynamically varying the QoS grade of at least one optimal path according to the tested transportation parameters and/or to the type of data packets to be sent from the source node to the destination node.

15. A method according to claim 13, wherein packets of an application, the type of which being selected from the group of {data, voice, video, multimedia}, are sent from the source node to the destination node through one or more optimal paths being optimal for the corresponding application type.

16. A method according to claim 13, further comprising splitting the transportation of data packets from the source node to the destination node between two or more optimal paths, such that more transportation is directed to, and distributed between, optimal paths having higher grades than the remaining optimal paths, and less transportation is directed to, and distributed between, said remaining optimal paths.

17. A method according to claim 1, wherein each one of the optimal paths, between a source node and a destination node, includes only one intermediate node, said intermediate node being a Router (RQnode) that is selected from one of the inherent Internet's backbone Routers, the address of which is known to said source node and the selected packets are transmitted from said source node to said destination node, via said RQnode, by generating, in said source node, a modified header, according to a first Header Modification Rule (HMR) rule.

18. A method according to claim 1, wherein each one of the optimal paths, between a source node and a destination node, includes at least two consecutive intermediate nodes, said intermediate nodes being BackBone Qnodes (BBQs) that are connected to strategic points in the Internet, the addresses of which are known to said source node and the selected packets are transmitted from said source node to said destination node, via the corresponding consecutive BBQs, by generating and attaching, in said source node, a modified header to said selected packets, said modified header is obtained by employing a second Header Modification Rule (HMR) rule, after which said modified header contains a corresponding sequence of consecutive addresses that corresponds to consecutive BBQs along the corresponding optimal path, said second rule comprises adding, to the header of said selected packets, the addresses of said BBQs, in an order which corresponds to the order of said consecutive BBQs nodes along said optimal path, starting from the destination node to the BBQ being directly connected to said source node, so that whenever said selected packets are forwarded to one of said BBQs, the address of the current BBQ is removed from the header of said selected packets, thereby revealing the address of the next BBQ, for allowing said current BBQ to forward said packets, until said packets reach the destination node.

19. A method according to claims 17 and 18, wherein each one of several optimal paths, between a source node and a destination node, includes one intermediate node (RQnode) and each one of the remaining optimal paths include at least two consecutive intermediate nodes (BBQs) that are connected to strategic points in the Internet, the addresses of said Routers and said BBQs being known to said source node, said source node being capable of determining which selected packets should be forwarded to the destination node via a Router (RQnode) or BBQs, and, accordingly, selecting the corresponding HMR rule, according to which the header of the corresponding packets is to be modified.

20. A method according to claims 17 and 18, wherein one, or more, optimal path(s) comprise(s) a combination of RQnode(s) and BBQ(s), being utilized as intermediate nodes, and the first/second HMR rules are employed by the corresponding source/BBQ node according to said combination.

21. A method according to claims 17, 19 and 20, wherein according to the first HMR rule, the address of the source node is replaced in the header of the selected packets, by said source node, with the address of the destination node, by employing the Internet Communication Massage Protocol (ICMP), in order to cause the corresponding intermediate node Router (RQnode) to forwarded said selected packets to said destination node.

22. A method according to claim 1, wherein a source/destination node may be utilized as intermediate node for other source/destination nodes.

23. A method according to claim 1, wherein the preselected alternative paths include a path that is a default path, which allows transferring data between the source node and the destination node by utilizing conventional software packages.

24. A data network having improved quality of transportation of selected data packets, comprising:
a) a plurality of nodes being access points to said data network, each of which may be a source from which said selected data packets can be sent, or a destination to which said selected data packets can be intended;
b) a plurality of intermediate nodes between said source and said destination, for generating a plurality of alternative paths, consisting of segments, for routing said selected data packets;
c) at one or more nodes and/or intermediate nodes, circuitry for sending a plurality of test packets from said source to said destination, along said preselected different paths defined by different intermediate nodes and their corresponding interconnecting segments;
d) processing means, for defining one or more optimal paths for delivering said selected data packets from said source to said destination according to said transportation parameters and optionally, also according to predefined parameters characterizing said segments, and for selecting a combination of segments, connected to nodes, and having the optimal sampled transportation parameters and/or predefined parameters, that connect said source to said destination;
e) at each source, processing means for generating a modified header, for each selected data packet, that contains a sequence of consecutive addresses that correspond to consecutive nodes along an optimal path and attaching said modified header to said selected data packet;
f) at each node along said optimal path, starting from the source:
f.1) processing means for processing said modified header and for extracting the address that corresponds to the next consecutive node;
f.2) circuitry for forwarding said selected data packet from said node to its consecutive node along said optimal path using the extracted address; and
g) at the destination node, processing means for removing said modified header from said selected data packet and for obtaining the original header of said selected data packet.

25. A data network according to claim 24, wherein the data network is the Internet.

26. A data network according to claim 24, in which one or more nodes are used as intermediate nodes.

27. A data network according to claim 24, in which the test packet does not contain a payload.

28. A data network according to claim 24, in which the transportation parameters are selected from the following group of parameters:
the delay time of data packets from source to destination;
the variation of said delay time; and
loss of packets.

29. A data network according to claim 24, in which data is concurrently delivered from a source to a destination over several paths.

30. A data network according to claim 29, comprising weighted distribution of data between paths.

31. A data network according to claim 30, in which the weighted distribution is determined according to the desired level of QoS between the source and the destination.

32. A data network according to claim 27, in which the definition of the optimal path is carried out by measuring and storing the time and/or the order of arrival of test packets through different paths from the source to the destination.

33. A data network according to claim 24, further comprising:
processing means for dynamically varying the definition of each optimal path from the source to the destination, according to the sampling results, and for sending data packets from said source to said destination over said new optimal path.

34. A data network according to claim 24, in which the optimal path consists of direct connection between the source and the destination.

35. A data network according to claim 24, in which the predefined parameters are selected from the following group of parameters:
cost;
availability;
agreements with ISPs;
data type;
agreement with customers.
Date and/or time

36. A data network according to claim 24, in which a grade is assigned to each optimal path according to the sampled transportation parameters and/or predefined parameters that correspond to a required QoS and/or to the type of data packets to be sent from the source to the destination.

37. A data network according to claim 36, further comprising processing means for dynamically varying the grade of at least one optimal path according to the sampled transportation parameters and/or to the type of data packets to be sent from the source to the destination.

38. A data network according to claim 36, in which voice packets are sent from the source to the destination through one or more optimal paths being optimal for voice.

39. A data network according to claim 36, wherein data packets are sent from the source to the destination through one or more optimal paths being optimal for data.

40. A data network according to claim 36, comprising processing means for splitting the transportation of data packets from the source to the destination through between two or more optimal paths, such that more transportation is directed to, and distributed between, optimal paths having higher grades than the remaining optimal paths, and less transportation is directed to, and distributed between, said remaining optimal paths.

41. A data network according to claim 24, wherein each one of the optimal paths, between a source node and a destination node, includes only one intermediate node, said intermediate node being a Router (RQnode) that is selected from one of the inherent Internet's backbone Routers, the address of which is known to said source node and the selected packets are transmitted from said source node to said destination node, via said RQnode, by generating, in said source node, a modified header, according to a first Header Modification Rule (HMR) rule.

42. A data network according to claim 24, wherein each one of the optimal paths, between a source node and a destination node, includes at least two consecutive intermediate nodes, said intermediate nodes being BackBone Qnodes (BBQs) that are connected to points in the Internet, the addresses of which are known to said source node and the selected packets are transmitted from said source node to said destination node, via the corresponding consecutive BBQs, by generating and attaching, in said source node, a modified header to said selected packets, said modified header is obtained by employing a second Header Modification Rule (HMR) rule and containing a corresponding sequence of consecutive addresses that correspond to consecutive BBQs along the corresponding optimal paths, said second rule comprises adding, to the header of said selected packets, the addresses of said BBQs, in an order which corresponds to the order of said consecutive BBQs nodes along said optimal path, starting from the destination node to the BBQ being directly connected to said source node, such that whenever said selected packets are forwarded to one of said BBQs, the address of the current BBQ is removed from the header of said selected packets, thereby revealing the address of the next BBQ, for allowing said current BBQ to forward said packets, until said packets reach the destination node.

43. A data network according to claims 41 and 42, wherein each one of several optimal paths, between a source node and a destination node, include one intermediate node (RQnode) and each one of the remaining optimal paths include at least two consecutive intermediate nodes (BBQs) that are connected to strategic points in the Internet, the addresses of said Routers and said BBQs being known to said source node, said source node being capable of determining which selected packets should be forwarded to the destination node via a Router (RQnode) or BBQs, and, accordingly, selecting the corresponding HMR rule, according to which the header of the corresponding packets is to be modified.

44. A data network according to claims 41 and 42, wherein one, or more, optimal path(s) comprise(s) a combination of RQnode(s) and BBQ(s), being utilized as intermediate nodes, and the first/second HMR rules are employed by the corresponding source/BBQ node according to said combination.

45. A data network according to claims 41 and 43, wherein according to the first HMR rule, the address of the source node is replaced in the header of the selected packets, by said source node, with the address of the destination node, by employing the Internet Communication Massage Protocol (ICMP), in order to cause the corresponding intermediate node Router (RQnode) to forwarded said selected packets to said destination node.

46. A data network according to claim 24, wherein the preselected alternative paths include a path that is a default path, which allows transferring data between the source node and the destination node by utilizing conventional software packages.
